(19) United States
(12) Patent Application Publication
(10) Pub. No.: US 2026/0104501 A1
(43) Pub. Date: Apr. 16, 2026

(54) METHOD AND DEVICE FOR DETECTING A TARGET OBJECT

(71) Applicant: Robert Bosch GmbH, Stuttgart (DE)

(72) Inventors: Rossen Michev, Stuttgart (DE); Johannes Fink, Karlsruhe (DE)

(21) Appl. No.: 19/299,790

(22) Filed: Aug. 14, 2025

(30) Foreign Application Priority Data
Oct. 14, 2024 (DE) 10 2024 209 954.6

(51) Int. Cl. G01S 13/536; G01S 7/35; G01S 13/931

(52) U.S. Cl. CPC G01S 13/536; G01S 13/931; G01S 7/356

(57) ABSTRACT

A method and a device for detecting a target object located in a shared field of view of at least two radar sensors of a radar device. The method includes: emission of a radar signal with at least one radar signal frame, by each radar sensor of the radar device, wherein start times of the radar signal frames emitted by the various radar sensors of the radar device have a time offset from one another; receipt of radar signals reflected by the target object by the radar sensors of the radar device; collection of the radar measurement data contained in the received radar signals, and sorting of the collected radar measurement data based on time stamps; and evaluation of the sorted radar measurement data using multi-frame integration (MFI) in order to detect the target object.

### CROSS REFERENCE

The present application claims the benefit under 35 U.S.C. § 119 of Germany Patent Application No. DE 10 2024 209 954.6 filed on Oct. 14, 2024, which is expressly incorporated herein by reference in its entirety.

### FIELD

The present invention relates to a method and a radar device for detecting a target object located in a shared field of view of at least two radar sensors of the radar device (RVOR).

### BACKGROUND INFORMATION

Germany Patent Application No. DE 103 48 226 A1 describes a radar system with a radar sensor which has a transmitting module, a receiving module and a feed network, wherein the transmitting module has a first plurality of sub-antennas and the receiving module has a second plurality of sub-antennas, and wherein, in a first operating mode, the feed network operates at least one sub-antenna of the transmitting module together with at least one sub-antenna of the receiving module in order to achieve a first, low angular resolution, and wherein, in a second operating mode, the feed network operates a group of sub-antennas of the transmitting module and a group of sub-antennas of the receiving module together in order to achieve a second, high angular resolution. The radar system is characterized in that, in at least one further operating mode, the feed network in each case operates at least one sub-antenna of the transmitting module together with a group of sub-antennas of the receiving module or a group of sub-antennas of the transmitting module together with at least one sub-antenna of the receiving module.

Germany Patent Application No. DE 10 2014 212 281 A1 describes an FMCW radar sensor and method for locating a radar target, in which FMCW radar measurements are carried out by means of transmitting antennas with different fields of view that differ in a beam width and/or in a range, wherein the measurements each comprise temporally nested sequences of ramps and measurements with different fields of view are temporally interwoven, ambiguous values for the relative velocity of the radar target are determined from a position of a peak in a two-dimensional spectrum; phase relationships between spectral values of spectra are checked for agreement with phase relationships expected for multiple of the determined values of the relative velocity, and on the basis of these an estimated value for the relative velocity of the radar target is selected from the determined, periodic values of the relative velocity.

The radar signals (typically ramps) of commercially available radar sensors for the automotive sector, e.g. linear chirp sequence frequency modulated continuous wave (LCS-FMCW), are nowadays arranged in a periodic frame structure as shown in FIG. 3. The radar signal is emitted during the duration TF of the frame F, followed by a pause P. The pause has a duration TP. The duration between the start of two consecutive frames F is called the cycle time TC.

The ratio of frame duration TF and cycle time TC (i.e., TF/TC) is called the duty cycle. Conventional radar sensors have frame durations TF of a few milliseconds to multiple tens of milliseconds and a duty cycle of less than 50%, e.g. 20%. The radar data from a frame F are typically stored in matrix form, in which each column contains the sample values within a ramp R.

Conventional radar signal processing essentially involves an FFT in both dimensions, i.e. a 2D FFT. After this calculation step, each column belongs to a velocity cell or Doppler cell and each row to a distance cell or beat frequency cell.

The Doppler separation capability Av of a radar sensor is inversely proportional to the coherent integration time, in this case the frame duration TF:

$$Δ v = \frac{{c}_{0}}{2 {f}_{T} {T}_{F}} \qquad ( 1 )$$

In equation (1), co is the velocity of light in m/s, fT is the frequency of the transmitted signal in Hz. For a conventional single sensor (without MFI), the Doppler shift and thus the velocity of a target object ZOBJ is calculated by means of an FFT-based estimation of the phase changes between the individual ramps R within a frame F. These are detected with a ramp repetition duration TR (see FIG. 2A, 2B, 2C), which, by the sampling theorem, results in the maximum unambiguous radial velocity vmax:

$${v}_{max} - {v}_{min} = \frac{{c}_{0}}{2 {f}_{T} {T}_{R}} \qquad ( 2 )$$

FIG. 4A, 4B, 4C show an exemplary arrangement of the modulation within a frame F. FIG. 4A shows equidistant FMCW chirps. FIG. 4B shows non-equidistant FMCW chirps and FIG. 4C shows an arbitrary modulation, e.g. OFDM.

The Doppler resolution can be improved by increasing the integration time. One approach in this respect is the integration of radar signals over multiple frames F, so-called multi-frame integration (MFI). A sketch thereof is shown in FIG. 3. This can be carried out, for example, by a long FFT in the Doppler dimension over multiple frames F (including the pauses P in between). The gaps or pauses P are filled with zeros. By taking into account multiple frames F, an additional integration gain is also obtained depending on the number N of integrated frames F. The length of the FFT along the range dimension remains unaffected. Alternatively, the data from consecutive frames F can be arranged along a third dimension. In this case, the velocity resolution can be improved by an FFT along the third dimension.

Regardless of the arrangement of the radar data, the pauses P between the frames F influence the unambiguous range in the Doppler dimension. Thus, the sampling time points for the high-resolution Doppler FFT are determined by the cycle time TC, which leads to a reduction of the maximum unambiguous radial velocity:

$${v}_{max , MFI} - {v}_{min , MFI} = \frac{{c}_{0}}{2 {f}_{T} {T}_{R}} \qquad ( 3 )$$

In other words, multi-frame integration MFI can resolve N points within an original Doppler cell, where N is the number of frames F taken into account. The unambiguous range with this increased resolution is limited to the size of the original Doppler cell without MFI [cf. equations (2) and (3)].

However, the thus achieved improvement in the Doppler resolution has, inter alia, the following disadvantages or weaknesses. The unambiguous range in the Doppler dimension is reduced by the relatively long pauses P (‘gaps’) between the individual frames F since the cycle time TC includes the pause duration TP of the pauses P. A conventional solution in this respect would be to increase the duty cycle (TF/TC=TF/(TF+TP)) by shorter pauses P or longer measurement duration. However, the duty cycle is physically upwardly limited, primarily due to the thermal load in the transmitter.

### SUMMARY

According to a first aspect, the present invention provides a method for detecting a target object located in a shared field of view of at least two radar sensors of a radar device. According to an example embodiment of the present invention, the method comprises the following steps:
emission of a radar signal with at least one radar signal frame, by each radar sensor of the radar device, wherein start times of the radar signal frames emitted by the various radar sensors of the radar device have a time offset from one another;
receipt of radar signals reflected by the target object by the radar sensors of the radar device;
collection of the radar measurement data contained in the received radar signals, and sorting of the collected radar measurement data on the basis of time stamps; and
evaluation of the sorted radar measurement data by means of multi-frame integration (MFI) in order to detect the target object.

A core feature of the present invention is that the evaluation of the data from multiple radar sensors is carried out with a time offset between the start times of the frames in order to achieve the highest possible (virtual) duty cycle across all radar sensors of the radar device.

The method according to an example embodiment of the present invention comprises the operation of multiple radar sensors (M>1) with a completely or partially overlapping field of view and an arbitrary time offset between the start times of the frames of the individual radar sensors.

The combination of the cooperative operation of at least two radar sensors and MFI results in the following advantages for target objects in the shared field of view of the radar sensors:

An SNR (signal-to-noise ratio) gain is achieved through the larger amount of available radar measurement data from multiple individual sensors.

An additional SNR gain is achieved through the extended integration time over multiple frames F.

Increased Doppler resolution is achieved through multi-frame integration (MFI) with a slight or no reduction in the unambiguously measurable velocity depending on the duty cycle of the overall system. The shortening of the pauses or gaps P makes it possible to increase the common (virtual) duty cycle up to 100% depending on the duty cycle and the number M of individual sensors used.

Finally, improved angular resolution is achieved through the increased aperture of the entire radar network comprising multiple individual sensors. However, this only applies if the radar sensors operate in a phase-coherent manner.

In a possible example embodiment of the method according to the present invention for detecting a target object, the various radar sensors of the radar device partially emit radar signals with overlapping radar signal frames.

In a possible example embodiment of the method according to the present invention for detecting a target object, the radar measurement data of the overlapping regions of the radar signal frames contained in the received radar signals are evaluated to estimate and/or compensate for unwanted offsets.

In a possible example embodiment of the method according to the present invention for detecting a target object, the radar measurement data of the overlapping regions of the radar signal frames contained in the received radar signals are evaluated to estimate and compensate for time offsets, frequency offsets, and/or phase offsets.

In a possible example embodiment of the method according to the present invention for detecting a target object, the radar measurement data of the overlapping regions of the radar signal frames contained in the received radar signals are evaluated to estimate and calibrate a time base of the radar sensors of the radar device.

In a possible example embodiment of the method according to the present invention for detecting a target object, the time offset of the radar signal frames emitted by the various radar sensors is achieved by a relative delay of a trigger signal for starting a radar measurement. This makes it easy to set the time offset.

In a possible example embodiment of the method according to the present invention for detecting a target object, a frequency offset between the radar sensors is estimated and corrected in the case of decoupled radar sensors that are not synchronized with one another and do not have a common reference.

In a possible example embodiment of the method according to the present invention for detecting a target object, the radar signals emitted by the radar sensors have a cycle time (TC) which is composed of a frame duration (TF) of a radar signal frame (TF) and a pause duration (TP) of a pause (P) existing between two consecutive frames of a radar signal.

In a possible example embodiment of the method according to the present invention for detecting a target object, a duty cycle of the radar signal emitted by a radar sensor is set, the duty cycle indicating the ratio of the frame duration (TF) of a radar signal frame (TF) to the cycle time (TC). This offers a high degree of flexibility for different use cases.

In a possible example embodiment of the method according to the present invention for detecting a target object, a virtual duty cycle of the radar signals emitted with a time offset by all radar sensors of the radar device is maximized.

In a possible example embodiment of the method according to the present invention for detecting a target object, the radar signal frames of the radar signals emitted by the radar sensors have ramps with an equidistant or non-equidistant ramp repetition duration.

In a possible example embodiment of the method according to the present invention for detecting a target object, the radar measurement data comprise sample values of a time signal or preprocessed range Doppler spectral data.

The method according to the present invention is preferably a computer-implemented method, in which the main data processing steps can be carried out on a processor.

The present invention further provides a radar device for detecting a target object located in a shared field of view of at least two radar sensors of the radar device. According to an example embodiment of the present invention, the radar device comprises: radar sensors which are each designed to emit a radar signal with at least one radar signal frame, wherein start times of the radar signal frames emitted by the various radar sensors of the radar device have a time offset from one another, and which radar sensors are designed to receive the radar signals reflected by the target object; a preprocessing unit which is designed to collect the radar measurement data contained in the radar signals received by the radar sensors and to sort the collected radar measurement data on the basis of time stamps; and comprising an evaluation unit which is designed to evaluate the radar measurement data collected and sorted by the preprocessing unit by means of multi-frame integration in order to detect the target object.

In a possible example embodiment of the radar device according to the present invention for detecting a target object, the radar sensors of the radar device have a predefined distance from one another.

In a possible example embodiment of the radar device according to the present invention for detecting a target object, the radar sensors of the radar device are mounted on a front side of a vehicle body of the vehicle and/or on a rear side of the vehicle body of the vehicle.

Possible embodiments of the method according to the present invention and of the radar device according to the present invention are described in detail below with reference to the figures.

### BRIEF DESCRIPTION OF THE DRAWINGS

FIG. 1 is a flowchart representing a possible embodiment of the method according to the present invention.

FIG. 2 is a block diagram schematically illustrating a possible embodiment of the radar device according to the present invention.

FIG. 3 is a signal diagram illustrating the data structure of a radar signal emitted by a radar sensor.

FIG. 4A, 4B, 4C are signal diagrams illustrating possible radar signals with ramps, with FIG. 4A and FIG. 4B showing ramps and FIG. 4C depicting a broadband modulation type such as OFDM.

FIG. 5A, 5B, 5C are signal diagrams illustrating radar signals which are emitted with different time offsets from one another by various radar sensors according to the method according to the present invention and whose data are combined at the receiving end.

FIG. 6, 7 show possible positioning options of the radar device according to the present invention on a vehicle body.

FIG. 8 is a signal diagram illustrating a possible embodiment of the method according to the present invention.

FIG. 9, 10, 11 are flowcharts illustrating possible embodiments of the method according to the present invention.

FIG. 12 is a further signal diagram illustrating the functioning of the method according to the present invention.

### DETAILED DESCRIPTION OF EXAMPLE EMBODIMENTS

The figures are intended to impart further understanding of example embodiments of the present invention. They illustrate embodiments and, in connection with the description, serve to explain principles and concepts of the present invention. Other embodiments and many of the mentioned advantages become apparent from the figures. The elements of the figures are not necessarily shown to scale relative to one another.

In the figures, identical, functionally identical and identically acting elements, features and components are provided with the same reference signs in each case, unless otherwise stated.

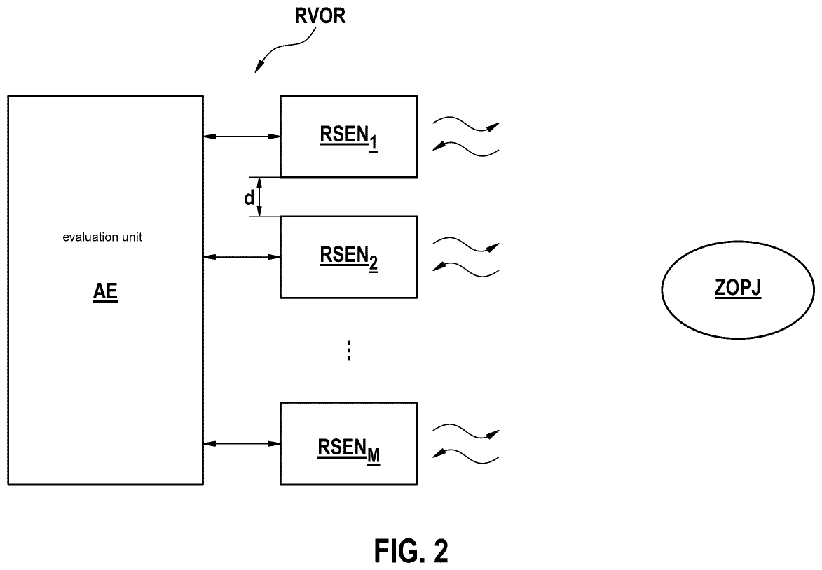

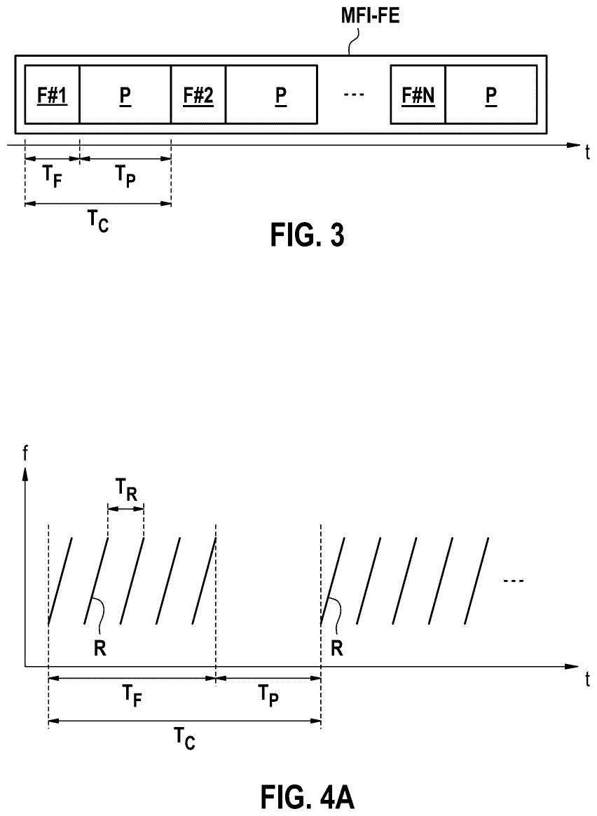

According to a first aspect, the present invention provides a method for detecting a target object ZOBJ located in a shared field of view of at least two radar sensors RSEN of a radar device RVOR, as shown schematically in FIG. 2.

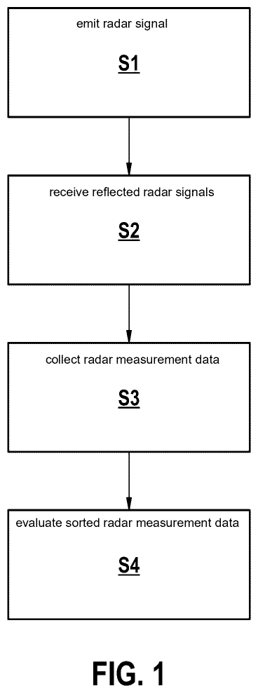

FIG. 1 is a flowchart of a possible embodiment of the method according to the present invention.

In a first step S1, a radar signal with at least one radar signal frame is emitted by each radar sensor of the radar device RVOR, wherein start times of the radar signal frames F emitted by the various radar sensors RSEN of the radar device RVOR have a time offset ZV from one another.

In a second step S2, radar signals reflected by the target object ZOBJ are received by the radar sensors RSEN of the radar device RVOR.

In a third step S3, the radar measurement data contained in the received radar signals are collected, and the collected radar measurement data are sorted on the basis of time stamps.

In a fourth step S4, the sorted radar measurement data are evaluated S4 by means of multi-frame integration (MFI) in order to detect the target object.

In the method according to the present invention, the evaluation of the data from multiple radar sensors RSEN is carried out with a time offset ZV between the start times of the frames F in order to achieve the highest possible (virtual) duty cycle across all radar sensors RSEN.

The method according to the present invention comprises the operation of a number M of radar sensors RSEN (M>1) with a completely or partially overlapping field of view and an arbitrary time offset ZV between the start times of the frames F of the individual radar sensors RSEN.

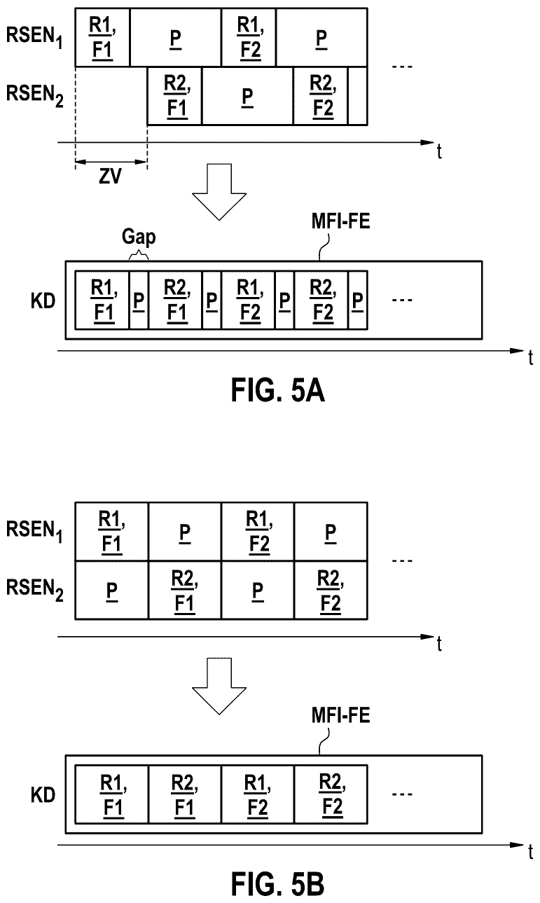

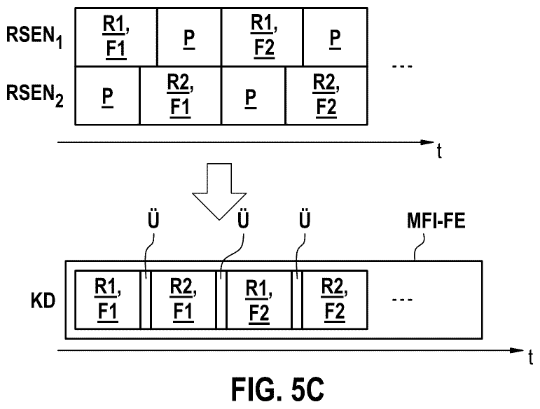

In a possible embodiment of the method according to the present invention for detecting a target object ZOBJ, the various radar sensors RSEN of the radar device RVOR partially emit radar signals with overlapping radar signal frames F (overlaps U), as shown in FIG. 5C. An MFI window MFI-FE comprises a number N of frames F which are received by various radar sensors and whose radar measurement data are combined (combined data kD), i.e. collected and sorted.

In a possible embodiment, the radar measurement data of the overlapping regions of the radar signal frames contained in the received radar signals can be evaluated to estimate and/or compensate for unwanted offsets. In a further embodiment of the method according to the present invention, the radar measurement data of the overlapping regions of the radar signal frames F contained in the received radar signals are evaluated to estimate and/or compensate for time offsets, frequency offsets, and/or phase offsets. In a possible embodiment of the method according to the present invention for detecting a target object, the radar measurement data of the overlapping regions of the radar signal frames F contained in the received radar signals are also evaluated to estimate and calibrate a time base of the radar sensors RSEN of the radar device RVOR.

In a possible embodiment of the method according to the present invention for detecting a target object ZOBJ, the time offset ZV of the radar signal frames F emitted by the various radar sensors RSEN is achieved by a relative delay of a trigger signal for starting a radar measurement.

In a possible embodiment of the method according to the present invention for detecting a target object, a frequency offset between the radar sensors RSEN is estimated and corrected in the case of decoupled radar sensors RSEN that are not synchronized with one another and do not have a common reference.

In a possible embodiment of the method according to the present invention for detecting a target object ZOBJ, the radar signals emitted by the radar sensors RSEN have a cycle time (TC) which is composed of a frame duration (TF) of a radar signal frame (TF) and a pause duration (TP) of a pause (P) existing between two consecutive frames (F) of a radar signal. A duty cycle of the radar signal emitted by an individual radar sensor RSEN can be set, the duty cycle indicating the ratio of the frame duration (TF) of a radar signal frame (TF) to the cycle time (TC).

In a possible embodiment of the method according to the present invention for detecting a target object ZOBJ, a virtual duty cycle of the radar signals emitted with a time offset by all radar sensors RSEN of the radar device RVOR is maximized.

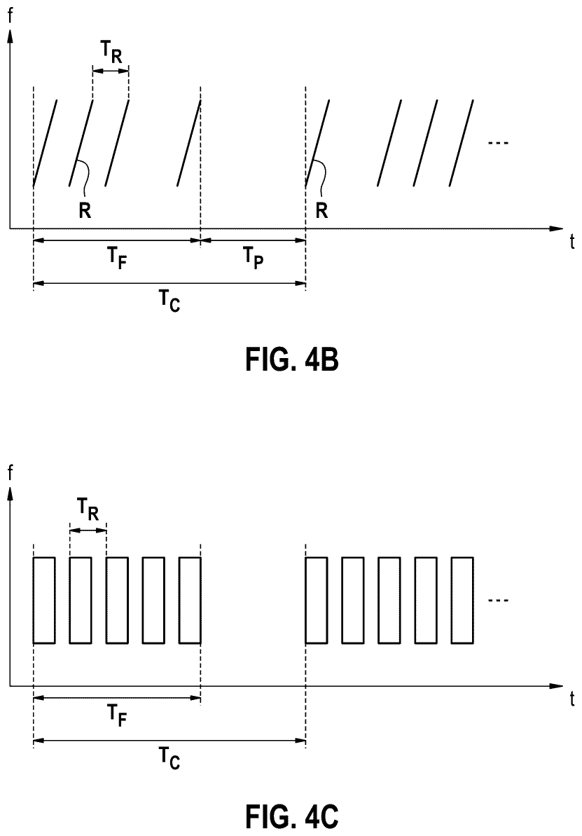

In a possible embodiment of the method according to the present invention for detecting a target object ZOBJ, the radar signal frames F of the radar signals emitted by the radar sensors RSEN have ramps R with an equidistant or non-equidistant ramp repetition duration (TR), as shown in FIG. 4A, 4B, 4C.

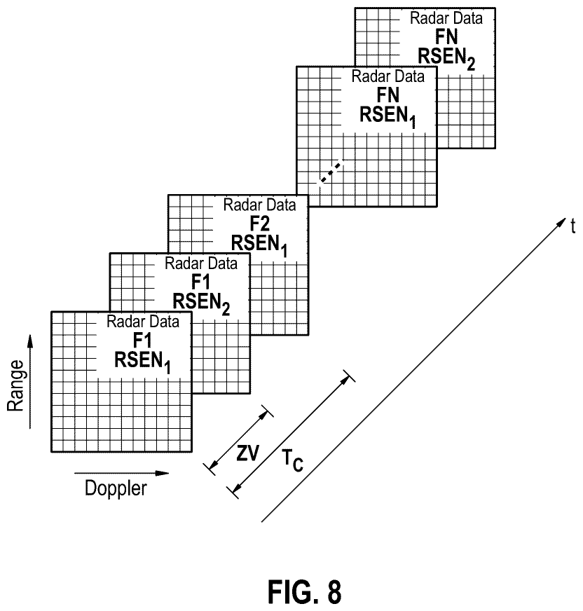

In a possible embodiment of the method according to the present invention for detecting a target object ZOBJ, the radar measurement data comprise sample values of a time signal or else already preprocessed range Doppler spectral data, as shown schematically in FIG. 8.

According to a further aspect, the present invention further provides a radar device RVOR for detecting a target object ZOBJ located in a shared field of view of at least two radar sensors RSEN of the radar device RVOR. FIG. 2 is a block diagram of a possible embodiment of the radar device RVOR according to the present invention.

The radar device RVOR comprises a number M of radar sensors RSEN which are each designed to emit a radar signal with at least one radar signal frame F, wherein start times of the radar signal frames F emitted by the various radar sensors RSEN of the radar device RVOR have a time offset ZV from one another. The radar sensors RSEN are also designed to receive the radar signals reflected by the target object ZOBJ.

The radar device RVOR also comprises a preprocessing unit which is designed to collect the radar measurement data contained in the radar signals received by the radar sensors RSEN and to sort the collected radar measurement data on the basis of time stamps. The preprocessing unit of a radar sensor RSEN is preferably integrated in a signal and data processing unit or evaluation unit AE of the radar device RVOR, as shown schematically in the block diagram according to FIG. 2.

The radar device RVOR has an evaluation unit AE which is designed to evaluate the radar measurement data collected and sorted by the preprocessing unit by means of multi-frame integration (MFI) in order to detect the target object ZOBJ.

In a possible embodiment of the radar device according to the present invention for detecting a target object ZOBJ, the radar sensors RSEN of the radar device RVOR have a predefined distance d from one another, as shown schematically in FIG. 2.

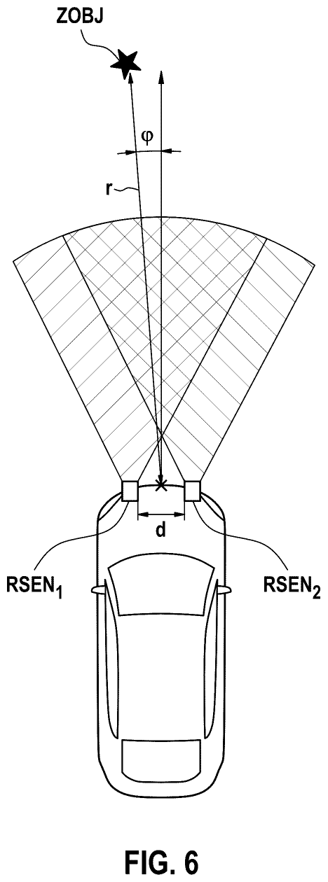

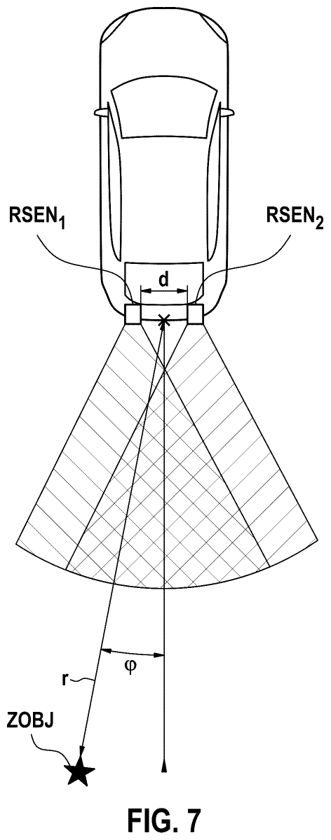

In a possible embodiment of the radar device RVOR according to the present invention for detecting a target object ZOBJ, the radar sensors RSEN of the radar device RVOR are mounted on a front side of a vehicle body of a vehicle (as shown in FIG. 6) and/or on a rear side of the vehicle body of a vehicle (as shown in FIG. 7).

An optimal selection or setting of the time offsets ZV between the frame start points of the radar sensors RSEN involved leads to minimization of the gaps or pauses P (see also FIG. 5A) or can even enable continuous, gapless recording and evaluation of the radar scene (see FIG. 5B) in the overlapping field of view of the radar sensors RSEN.

For this purpose, the radar sensors RSEN are synchronized in the time domain and frequency domain. Phase synchronization is not required, but additionally enables cooperative coherent angle estimation by means of the total aperture of the sensor network.

A further embodiment with two radar sensors RSEN 1, RSEN 22, each having a duty cycle>50% and emitting partially overlapping frames F, is shown in FIG. 5C. The overlapping regions U shown in FIG. 5C can be used, for example, to estimate and compensate for unwanted time offsets, frequency offsets, or even phase offsets. By operating with a suitable time offset ZV, a seamless measurement with overlapping regions is achieved. The overlapping regions U can be used, for example, to estimate and calibrate the time base of the two radar sensors RSEN 1, RSEN 2.

Particularly interesting for both multi-frame integration MFI and the cooperative operation of multiple radar sensors RSEN are distant target objects ZOBJ in the shared field of view of the individual sensors. The detection of such target objects ZOBJ requires a very high sensitivity and a fine angular resolution of the radar measurement.

FIG. 6 shows a symmetrical arrangement of two radar sensors RSEN 1, RSEN 2 at the front of a vehicle. The spatial distance between the two radar sensors RSEN 1, RSEN 2 is d. The sensor midpoint is marked by a cross in FIG. 6. A target object ZOBJ at a distance r under the azimuth angle φ, from the sensor midpoint point relative to the driving direction axis, is located in the shared angle of view of the two radar sensors RSEN.

For the exemplary arrangement in FIG. 6, the greatest added value is expected for target objects ZOBJ located directly in front of or behind the vehicle (i.e. at φ=) 0°. φ is defined as the angle between the line-of-sight target vector and the vector along the driving direction, starting from the center position of all radar sensors RSEN involved. The further away the target objects ZOBJ are in comparison to the distance d between the individual sensors RSEN, i.e. for r/d>>1, the more similar the echoes of the target objects are for the individual radar sensors RSEN. For radar sensors RSEN at the front of the vehicle (as shown in FIG. 6), this applies especially to target objects ZOBJ close to 0°, e.g. another vehicle, lost cargo, a bridge, or a sign above a lane that is traveled on. For radar sensors RSEN at the rear of the vehicle (as shown in FIG. 7), this is the case for target objects ZOBJ close to φ=180°, e.g. a motorcycle approaching from behind. For such target objects ZOBJ, the integration of the data from multiple radar sensors RSEN should not cause any artifacts, since any gaps or discontinuities can be kept negligibly small.

The joint evaluation of the radar data of multiple individual sensors RSEN with time-offset measurement cycles can be carried out as follows.

First, the time offset ZV is determined and, if necessary, created so that the time gaps or pauses P between the frames F or measurements of the individual sensors RSEN are covered as well as possible by the entirety of the radar sensors RSEN.

The time offset ZV can be achieved, for example, by a relative delay of the trigger signal between the individual sensors RSEN for starting the measurement. If there is no option to set the time offset ZV, the time offset ZV is either predefined or estimated so that the radar data can be assembled chronologically correctly. In this case, the gaps P would not be optimally filled, since the frames F might overlap, but the signal processing of the assembled data is expected to yield the same SNR gain and a partial improvement in the unambiguous range in comparison to an optimal filling of the gaps P.

Subsequently, the frequency offset for decoupled individual sensors RSEN with free-running oscillators is estimated. The latter can be measured and/or compensated for, for example, by means of circuits, such as mixers or frequency-locked loops, or ascertained from the radar data via offsets between the ramps R of the individual sensors RSEN or via the frequency spacing between the carriers or the pilot signals (in digital modulation methods). Alternatively, the time and frequency offsets between the radar sensors RSEN involved can be calibrated or a common reference can be used.

In a first step S1 of the method according to the present invention, as shown in the flowchart according to FIG. 1, at least one frame F per radar sensor RSEN is emitted by all M individual sensors RSEN involved.

In a further step S2, the radar measurement data of the individual sensors RSEN are received and transmitted in frames F or as raw data (e.g. sample values of the analog-to-digital converters) to a central processing unit or evaluation unit AE or to one of the radar sensors RSEN involved, if this radar sensor RSEN has an integrated processing unit (e.g. system-on-chip, SoC). If the time stamps TS of the individual frames F are unknown in the processing unit and cannot be calculated, they are transmitted together with the radar data so that the correct assignment along the common time axis t can take place.

If the trigger signals for starting the measurement in each individual sensor RSEN are generated from one signal source, temporal synchronization by a control loop is usually not required. However, if this is not the case, or for very long MFI integration intervals, temporal synchronization is preferably carried out by means of a control loop. In addition, phase synchronization may be required for certain applications, such as fully coherent angle estimation with the entire antenna array of the radar network. The radar measurement data can then be corrected by means of the ascertained offset values before the MFI evaluation. Furthermore, the data can be corrected by means of motion compensation algorithms.

In a further step S3 of the method according to the present invention shown in FIG. 1, the radar measurement data are arranged along the common time axis or the time axis t of the processing unit on the basis of the transmitted or calculated time stamps TS of the individual measurements. The radar measurement data can be either the time signals or raw data from the AD converters or already processed range Doppler spectra of the individual measurements (see FIG. 8).

Finally, in a step S4 of the method according to the present invention shown in FIG. 1, the assembled (combined) radar measurement data kD are processed by means of MFI algorithms. If raw data are available, they can be processed after assembly by means of a sliding window algorithm.

Various parameters relating to the target object ZOBJ can be ascertained or calculated in step S4, in particular an angle to the target object ZOBJ, a velocity of the target object ZOBJ, and a current distance of the target object ZOBJ from the radar device RVOR.

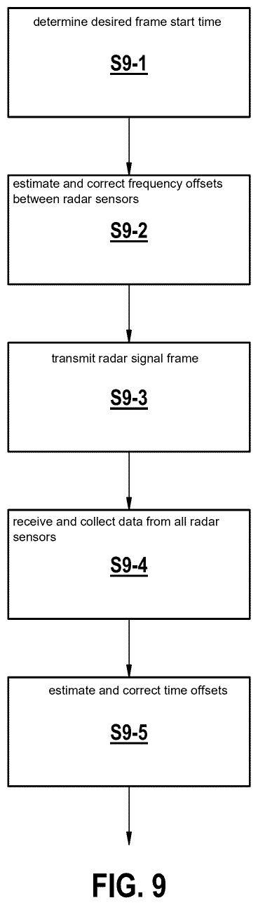

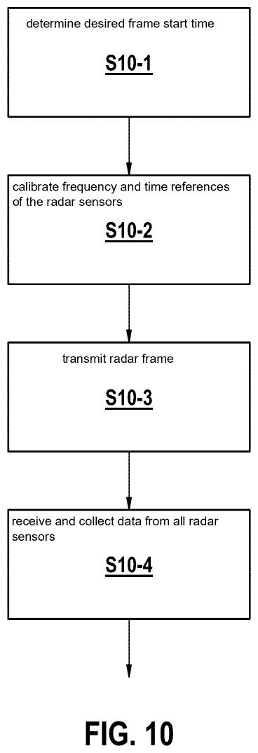

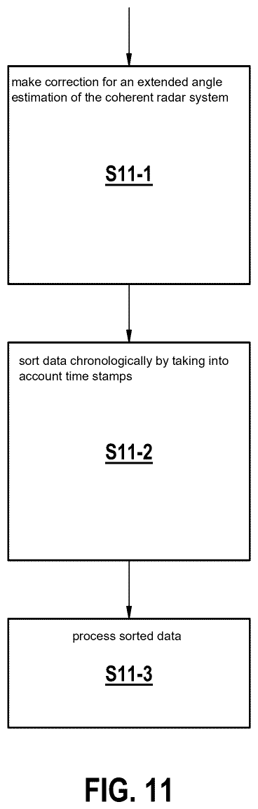

FIGS. 8 and 9 show the first part of the radar measurement process. FIG. 8 shows an exemplary arrangement of the radar measurement (frame) of two individual sensors RSEN 1, RSEN 2. TC denotes the cycle time of an individual sensor RSEN. By using an additional radar sensor and a suitable time offset ZV, the temporal resolution between the frames F of the individual sensors RSEN is refined due to the higher common duty cycle.

For the uncalibrated (decoupled) individual sensors RSEN, the process shown in FIG. 9 is relevant. FIG. 9 is a flowchart of the signal processing (part 1) according to a first variant without calibration or common reference. The continuation or the second part of the signal processing is shown in the flowchart according to FIG. 11.

First, in a first step S9-1, a desired frame start time of a frame F is determined for each radar sensor RSEN.

In a further step S9-2, frequency offsets between the radar sensors RSEN are estimated and corrected.

In a further step S9-3, at least one radar signal frame F is transmitted by a number M of radar sensors RSEN (according to step S1 of the method according to the present invention).

In a further step S9-4, data from all radar sensors RSEN are received and collected (according to step S2 of the method according to the present invention).

In a further step S9-5, time offsets are estimated and corrected.

The flowchart in FIG. 10 according to a second variant applies when using calibrated radar sensors RSEN or a common reference. The continuation or second part of the signal processing is shown in FIG. 11.

In a first step S10-1, a desired frame start time of a frame F is determined for each radar sensor RSEN (analogously to step S9-1).

In a further step S10-2, the frequency and time references of the M radar sensors RSEN are calibrated or a common reference is used.

In a further step S10-3, at least one radar signal frame F is transmitted by a number M of radar sensors RSEN (analogously to step S9-3 and according to step S1 of the method according to the present invention).

In a further step S10-4, data from all radar sensors RSEN are received and collected (analogously to step S9-4 and according to step S2 of the method according to the present invention).

FIG. 11 shows the second part of a flowchart of the signal processing. This second part of the signal processing is identical for the two variants according to FIGS. 9 and 10.

In a first step S11-1, a correction is made for an extended angle estimation of the coherent radar network based on the time offset ZV between the frames F of the individual radar sensors RSEN (motion compensation).

In a further step S11-2, the data are sorted chronologically by taking into account the time stamps TS of each frame F from each radar sensor RSEN (according to step S3 of the method according to the present invention).

Subsequently, in a step S11-3, the sorted data are processed using an MFI algorithm (according to step S4 of the method according to the present invention).

The individual FMCW ramps R or OFDM symbols of FIG. 4 do not have to be emitted equidistantly. In addition, the center frequency and/or the ramp repetition duration TR of the ramps R can change over time.

FIG. 5A, 5B, 5C show exemplary arrangements of only two radar sensors RSEN1, RSEN2. The number of radar sensors RSEN that are evaluated together is basically limited only by the available storage and computing capacities. In addition, the duty cycles can differ between the individual RSEN sensors or even change over time within a radar sensor RSEN.

FIG. 5A shows frames F emitted with a time offset ZV by two radar sensors RSEN 1, RSEN2. The long-lasting pause P, which is longer than the time offset ZV (Tp>ZV), between the frames F leads to small pauses P in the combined data kD.

FIG. 5B shows a further case in which the time offset ZV of the frames F emitted by two radar sensors RSEN 1, RSEN2 corresponds exactly to the duration of a pause or gap P between emitted frames F (Tp=ZV) so that the combined data kD no longer have any gaps.

FIG. 5C shows a further case in which the time offset ZV of the frames F emitted by two radar sensors RSEN 1, RSEN2 is longer than the duration of a pause or gap P between emitted frames F (ZV>Tp) so that overlaps U occur in the combined data kD.

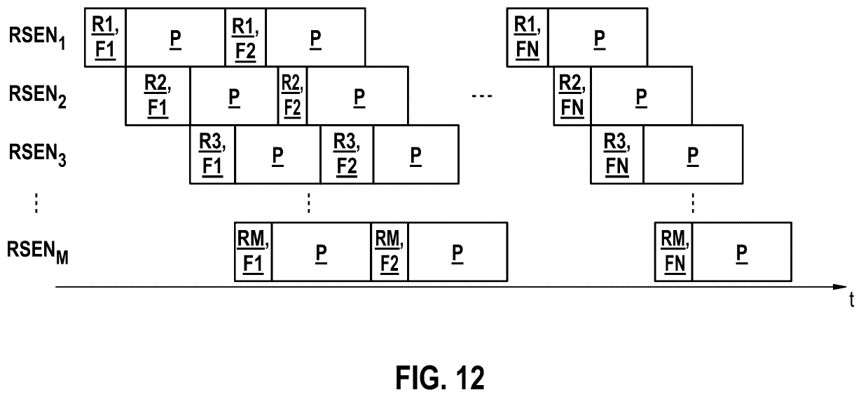

A general sketch of these various alternatives with a number M of radar sensors RSEN is shown in FIG. 12. For increased storage efficiency and computational efficiency, it is also possible to evaluate only parts (so-called regions of interest) of the individual frames F. These regions of interest may, for example, comprise individual range Doppler cells or regions of multiple cells in order to increase the signal-to-noise ratio (SNR) and/or the Doppler resolution within this region.

The assembled radar measurement data of the individual sensors RSEN do not necessarily have to be divided into discrete frames F. Shifted segments of any length from the assembled time signals of the individual radar sensors RSEN can also be evaluated, for example by means of a sliding window algorithm. This is especially interesting for a virtual duty cycle of or of almost 100% since the pauses or gaps P between the data from various radar sensors RSEN would be negligibly small in this case. The individual measurements (frames) in FIG. 8 can have more than two dimensions. For a multiple-input multiple-output (MIMO) radar apparatus, an azimuth and possibly an elevation dimension may, for example, be present after the angle estimation. The combined data kD will accordingly also have this dimensionality.

FIGS. 6 and 7 show an arrangement with two radar sensors RSEN 1, RSEN 2 at the front and rear of the vehicle respectively. The alignment or mounting position of the radar sensors RSEN is not limited thereto. What is important for the approach is that the radar sensors RSEN have an at least partially overlapping field of view. For example, if the radar sensors RSEN are mounted on the rear of the vehicle, the proposed approach can be used, for example, to detect weak targets, such as motorcycles at a great distance behind the vehicle, in a timely manner. However, depending on the duty cycle of the individual RSEN sensors, the combined data can have very large overlaps, and thus a high level of redundancy, from a certain number M of radar sensors RSEN on. In such configurations, the combined data may be formed by calculating the mean from the data of the individual sensors RSEN, provided that the respective pauses P have been filled with zeros.

The approach according to the present invention is not only applicable to ‘conventional’ FMCW-modulated radar apparatuses. Since the processed range Doppler spectra of the individual sensors RSEN are preferably fused first, the approach according to the present invention is basically independent of the modulation used.

Although the present invention has been completely described above with reference to preferred exemplary embodiments, it is not limited thereto, but can be modified in many ways.

What is claimed is:

1. A method for detecting a target object located in a shared field of view of at least two radar sensors of a radar device, the method comprising the following steps:
emitting a radar signal with at least one radar signal frame, by each radar sensor of the radar device, wherein start times of the radar signal frames emitted by the radar sensors of the radar device have a time offset from one another;
receiving radar signals reflected by the target object by the radar sensors of the radar device;
collecting radar measurement data contained in the received radar signals, and sorting of the collected radar measurement data based on time stamps; and
evaluating the sorted radar measurement data using multi-frame integration (MFI) in order to detect the target object.

2. The method according to claim 1, wherein the radar sensors of the radar device partially emit radar signals with overlapping radar signal frames.

3. The method according to claim 2, wherein the radar measurement data of overlapping regions of the radar signal frames contained in the received radar signals are evaluated to estimate and/or compensate for unwanted offsets.

4. The method according to claim 3, wherein the radar measurement data of the overlapping regions of the radar signal frames contained in the received radar signals are evaluated to estimate and compensate for time offsets, and/or frequency offsets, and/or phase offsets.

5. The method according to claim 2, wherein the radar measurement data of the overlapping regions of the radar signal frames contained in the received radar signals are evaluated to estimate and calibrate a time base of the radar sensors of the radar device.

6. The method according to claim 1, wherein the time offset of the radar signal frames emitted by the radar sensors is achieved by a relative delay of a trigger signal for starting a radar measurement.

7. The method according to claim 1, wherein a frequency offset between the radar sensors is estimated and corrected in the case of decoupled radar sensors that are not synchronized with one another and do not have a common reference.

8. The method according to claim 1, wherein the radar signals emitted by the radar sensors have a cycle time which is composed of a frame duration of a radar signal frame and a pause duration of a pause existing between two consecutive frames of a radar signal.

9. The method according to claim 8, wherein a duty cycle of the radar signal emitted by a radar sensor is set, the duty cycle indicating a ratio of the frame duration of a radar signal frame to the cycle time.

10. The method according to claim 9, wherein a virtual duty cycle of the radar signals emitted with a time offset by all radar sensors of the radar device is maximized.

11. The method according to claim 1, wherein the radar signal frames of the radar signals emitted by the radar sensors have ramps with an equidistant or non-equidistant ramp repetition duration.

12. The method according to claim 1, wherein the radar measurement data include sample values of a time signal or preprocessed range Doppler spectral data.

13. A radar device for detecting a target object located in a shared field of view of at least two radar sensors of the radar device, the radar device comprising:
radar sensors which are each configured to emit a radar signal with at least one radar signal frame, wherein start times of the radar signal frames emitted by the radar sensors of the radar device have a time offset from one another, and the radar sensors are configured to receive radar signals reflected by the target object;
a preprocessing unit which is configured to collect radar measurement data contained in the radar signals received by the radar sensors and to sort the collected radar measurement data based on time stamps; and
an evaluation unit configured to evaluate the radar measurement data collected and sorted by the preprocessing unit using multi-frame integration (MFI) in order to detect the target object.

14. The radar device according to claim 13, wherein the radar sensors of the radar device have a predefined distance from one another.

15. A vehicle, comprising:
a radar device for detecting a target object located in a shared field of view of at least two radar sensors of the radar device, the radar device including:
radar sensors which are each configured to emit a radar signal with at least one radar signal frame, wherein start times of the radar signal frames emitted by the radar sensors of the radar device have a time offset from one another, and the radar sensors are configured to receive radar signals reflected by the target object,
a preprocessing unit which is configured to collect radar measurement data contained in the radar signals received by the radar sensors and to sort the collected radar measurement data based on time stamps, and
an evaluation unit configured to evaluate the radar measurement data collected and sorted by the preprocessing unit using multi-frame integration (MFI) in order to detect the target object;
wherein the radar sensors of the radar device are mounted on a front side of a vehicle body of the vehicle and/or on a rear side of the vehicle body of the vehicle.
